(19) United States
(12) Patent Application Publication
(10) Pub. No.: US 2016/0075608 A1
(43) Pub. Date: Mar. 17, 2016

(54) PRODUCTION OF NUTRIENT-RICH BIOCHAR FROM A RESIDUAL MATERIAL

(71) Applicant: EKOBALANS FENIX AB, Lund (SE)

(72) Inventor: Gunnar THELIN, LÖBERÖD (SE)

(21) Appl. No.: 14/888,751

(22) PCT Filed: Apr. 30, 2014
(86) PCT No.: PCT/SE2014/050532

§ 371 Date: Nov. 3, 2015

(30) Foreign Application Priority Data
May 24, 2013 (SE) 1350636-5

(51) Int. Cl. C05B 17/00

(52) U.S. Cl. CPC C05B 17/00

(57) ABSTRACT

The present invention describes a process for the treatment of a residual product for the production of a biochar, said process comprising: —providing a residual product material comprising at least phosphorous; said process also involving —performing a thermal treatment of the residual product material in a temperature of 800-1100° C. in at least a low oxygen containing environment, for the for the separation of volatiles in a stream also comprising at least cadmium (Cd), if present, and for the production of a nutrient-rich biochar comprising phosphorous.

### FIELD OF THE INVENTION

The present invention relates to a process for the treatment of a residual product for the production of a biochar.

### TECHNICAL BACKGROUND

Different treatments of residual products, such as e.g. sludge or digestion residues, are known. For instance in WO 2011/128513 there is disclosed a process comprising the refining of municipal solid waste (MSW) to produce methane using an anaerobic digestion process for the treatment of the biodegradable fraction of MSW. The method comprises the steps of: a) municipal solid waste (MSW) is fed to a pretreatment where a biodegradable fraction is separated there from and recovered; b) the biodegradable fraction from step a) is fed to an anaerobic digestion process where biogas and a liquid reject is produced, and the biogas containing methane is recovered; and c) at least a fraction of the remaining part of the waste from step a) wherefrom a biodegradable fraction has been separated is pyrolysed in a pyrolysis unit.

Moreover, in WO2010/135818 there is disclosed a method of forming a pyrolysed biocarbon from a pyrolysable organic material. A carbonization circuit is employed with individual feedstock segments being advanced through the circuit. The method is said to facilitate user manipulation of rate of advancement of the feedstock through the circuit, selective collation of volatiles from pyrolysing feedstock, selective exposure of predetermined feedstock segments to collated volatiles as well as thermal recovery and redistribution as desired by the user. The method results in the capacity for a customizable biocarbon product.

As mentioned above, the present invention is directed to a process for the processing and refinement of a residual product, such as sludge, digestion residues, waste, or the like, for the production of a nutrient-rich biochar. One aim of the present invention is to provide a process which is cost-effective and which renders an optimized biochar product which is free from unwanted input substances but at the same time has a high content of nutrient input, such as phosphorous.

### SUMMARY OF THE INVENTION

The stated purpose above is achieved by a process for the treatment of a residual product for the production of a biochar, said process comprising:
providing a residual product material comprising at least phosphorous; said process also involving
performing a thermal treatment of the residual product material in a temperature of 800-1100° C. in at least a low oxygen containing environment, for the for the separation of volatiles in a stream also comprising at least cadmium (Cd), if present, and for the production of a nutrient-rich biochar comprising at least phosphorous.

Inter alia the following may be generally mentioned in relation to the summary of the present invention:

The residual product material may also comprise considerable amounts of other plant nutrients besides phosphorous, such as e.g. potassium.

It may further be said that the expression “a low oxygen containing environment” may e.g. imply or instead be defined as “without oxygen supply” or “without air supply”. Therefore, according to one specific embodiment of the present invention, the thermal treatment is pyrolysis, where pyrolysis implies without oxygen supply.

Moreover, it should be noted that a possible synonym of “biochar” which is sometimes used is “biocarbon”.

It should further be noted that the expression “residual product” is according to the present invention intended to embody all possible kinds of such starting material, such as sludge, digestion residues, waste, manure, etc., both digested and non-digested types.

The dry matter level of the starting material is 15-40%, such as 20-30%, e.g. 20-25% or 25-30%, e.g. about 25%.

According to the present invention, the temperature range in the thermal treatment is important in order to destruct pathogenic material, organic residues like pharmaceutical residues, hormones, and organic pollutants, also to ensure to separate a heavy metal like cadmium (Cd) by driving it with the volatile stream, and to provide a high nutrient content of at least phosphorus (P) in a biochar product without producing other unwanted by-products in the process. Such unwanted by-products are e.g. polyaromatic hydrocarbons (PAHs). If a too low temperature would be used in the thermal treatment, cadmium would not evaporate and be able to separate. If a too high temperature would be used, also phosphorous would evaporate together with e.g. cadmium. Furthermore, also the low oxygen containing environment or more or less oxygen free environment is of interest to suppress the formation of PAHs.

Moreover, cadmium is far better separated when pyrolysis or pyrolysis like conditions and a relatively higher temperature is employed. For instance, if a reduced gas atmosphere is used and a pyrolysis temperature of about 850° C. is employed, all cadmium may be found in the volatile stream/gas phase separated off.

In CN 1012173931 there is disclosed a production method of an animal manure carbon fertilizer. Raw materials used are animal manures. The production method of the animal manure carbon fertilizer comprises the following steps of: a, mixing organic granules; b, dryly granulating; c, carrying out carbonization processing; d, water-cooling; e, screening; and f, back-mixing, and granulating. The organic matters contained in the animal manures are said to be converted into biological carbon by heating the animal manures at high temperate in a low-oxygen environment.

As mentioned above, the temperature range used in the process according to the present invention is of importance to ensure the separation of a volatiles stream holding substances undesirable in the biochar. One such important example is cadmium. The temperature range, the separation of volatiles, or the relevance thereof is not disclosed or hinted in CN 1012173931.

Moreover, in JP 2006088020 there is disclosed a stabilizing treatment method for a carbonized product obtained from sewage sludge. Dewatered sludge in concentrated sludge generated after sewerage waste water treatment is subjected to hot air drying and the dried sludge is subjected to dry distillation treatment so as to produce a carbonized product. The dewatered sludge before or after the drying operation is mixed with an inorganic chemical for stabilizing harmful substances.

Even if a higher temperature is presented in JP 2006088020, when being compared to CN 1012173931, the method disclosed in JP 2006088020 is not directed to separation of a volatiles stream to ensure the separation of e.g. cadmium or the like. The method according to JP 2006088020 instead involves a step of mixing the material with an inorganic chemical for stabilizing harmful substances so as to provide a stream in which such the existence of such substances are suppressed. This differs from the present invention.

Furthermore, in U.S. Pat. No. 8,361,186 there are disclosed methods, devices, and systems for pyrolyzing biomass. Inter alia, the separation of a volatiles stream holding e.g. cadmium, if present, such as disclosed by the present invention, is not mentioned or hinted in U.S. Pat. No. 8,361,186. Furthermore, U.S. Pat. No. 8,361,186 actually also suggests a lower temperature range than possible to employ according to the present invention.

### BRIEF DESCRIPTION OF THE DRAWINGS

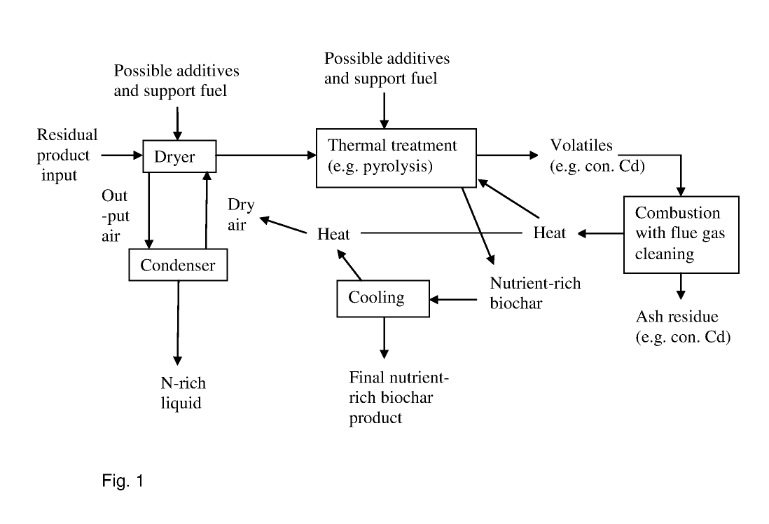

In FIG. 1 there is shown an example of a process flow according to one embodiment of the present invention.

### SPECIFIC EMBODIMENTS OF THE INVENTION

Below, specific embodiments of the present invention are presented.

One unique feature of the present invention is that the output liquid from the condenser in fact has a composition and is used as a valuable product and resource. In many corresponding plants for treating residual materials, like sludge or so, corresponding streams are only treated as something to deposit or the like. Fact is that the output liquid flow from the condenser according to the present invention is a nitrogen-rich liquid and as such is a nutrient product liquid. Moreover, the nitrogen-rich condensate also has a relatively high pH value. This is an advantage in terms of the possibility of combining the condensate with other nitrogen-rich streams before a stripping process in a nitrogen extraction plant. As such, the need for pH increasing additives is lowered.

Furthermore, the level of nitrogen in the liquid may be controlled according to the present invention, if this is of interest. One way of doing this is by using additives. Therefore, according to one specific embodiment of the present invention, a pH-regulating additive is added before the thermal treatment. By for example using a pH increasing additive, it is possible to increase the level of nitrogen being present in this liquid output flow. If a pH decreasing additive is used it is possible to increase the level of nitrogen following the phosphorous to the thermal treatment. It should once again clearly be stated that normally a nitrogen-rich liquid residue is only seen as a problem from which nitrogen has to be removed at substantial costs in order to meet threshold values for discharge to a recipient.

It is important to realize that also other additives are possible according to the present invention. Examples thereof are support fuels, which is further discussed below, or a chloride containing material, although the latter is a corrosive material which may cause problems in used equipment. A chloride substance, such as calcium chloride may suitably be used as an additive before or in the thermal treatment step, suitably to ensure that the separation of some unwanted substances are increased so that these levels are low in the biochar composition produced. When using chloride, there is a risk for also removing potassium together with the volatiles. Therefore, additives binding potassium may be used. Examples thereof are different silicates, such as aluminium silicates, e.g. kaolin. Moreover, some residual product materials contain silicates naturally which may have a positive effect if a chloride is used. Therefore, according to one specific embodiment at least one additive of a chloride containing material and a silicate is added before the thermal treatment. As mentioned, a silicate may also be present in the used starting material. Furthermore, the addition of chloride and/or silicate may be performed before the drying operation also.

As described above, the temperature range in the thermal treatment is of importance in the present process. According to one embodiment, the thermal treatment is performed in a temperature of from 800-1000° C. Furthermore, the thermal treatment may be operating with different technology, but there are some important aspects to consider. One first aspect is to exclude regular oxidative combustion, such as in a solid fuel boiler. Such combustion may produce undesired by-products when using materials disclosed herein, and also provides particulate material. According to one embodiment of the present invention, the volatiles separated in the thermal treatment are free from particulate material, which is one positive feature when being compared to using regular incineration.

A second aspect in relation to the thermal treatment is to provide a technology where the oxygen level is controlled at a very low level, preferably suppressed. Therefore, gasification is a technology possible to use, however there may be a risk for PAHs being produced. According to one specific embodiment, where the problems disclosed above are eliminated, is pyrolysis. Therefore, according to one embodiment the thermal treatment is pyrolysis. Different forms of pyrolysis are possible, such as flash pyrolysis or e.g. vacuum driven pyrolysis. The main aspect to be concerned when choosing the form of pyrolysis, when this is to be the thermal treatment form, is the cost of equipment, need of conditions in a certain process, etc. In a regular process according to the present invention, a regular pyrolysis set-up and equipment therefore should be fully possible to use.

As mentioned above, the thermal treatment according to the present invention may involve destruction of pathogenic material, organic residues like pharmaceutical residues, hormones, and organic pollutants, if present.

Moreover, and as mentioned above, additives may be used in different steps according to the present invention. One such is support fuels. Therefore, according to one embodiment, a support fuel is added before or in the drying operation and/or the thermal treatment. A support fuel is a material having a higher energy value than the input material being dried or pyrolysed in this case.

According to one specific embodiment, straw or horse-dung is added before or in the thermal treatment. Both such additives may be used as support fuels, for instance before or in a pyrolysis step. As straw is used as horse bedding, also horse-dung contains many of the substances present in straw. Both these material types are potassium (K)-rich which also is of interest for a biochar end product according to the present invention.

As an example it may be mentioned that horse manure may be mixed with a dried sludge before a pyrolysis step according to the present invention. This may produce a biochar product rich in both phosphorous and potassium and where the levels of possible undesired substances, such as copper (Cu), zinc (Zn), nickel (Ni) and lead (Pb), are suppressed. For instance, a straw ash may contain about 16 wt % potassium. If a regular sludge is mixed (50/50) with horse manure, a biochar product according to the present invention having a level of about 5-7 wt % potassium and about 3-4 wt % phosphorous may be obtained. Such a biochar product would have a very effective nutrient profile. In this context it may also be mentioned that a produced biochar product may be mixed in a subsequent step in which e.g. other residual product flows may be integrated, such as struvite and/or ammonium sulphate from a sludge dewatering stream, possible other ash residuals, potassium-rich minerals, etc.

The present invention may be performed on residual product material of different type, e.g. having different dry matter levels. According to one specific embodiment, the thermal treatment is conducted on a residual product material having a dry matter level of at least 75%, such as at least 85%, e.g. in the range of 85-95%. Moreover, the present invention may also involve a drying operation. According to one embodiment, a drying operation performed in a temperature below 105° C. is conducted on the residual product material before the thermal treatment. The residual product material in such a case, which also may be called a starting material, may in fact have a dry matter level of e.g. 15-40% before the drying operation.

According to one embodiment, the drying operation is performed in a temperature of 40-70° C. This temperature range is of interest as such an operational temperature may be heated by heat exchange with e.g. conventional district heating media or e.g. residual heat from district heating plants. Furthermore, the drying operation according to the present invention may be so called indirect, i.e. driven only by heat exchange, or direct by using a directly acting heating medium which is added to the residual product starting material when this is being dried. According to one specific embodiment, the drying operation is performed with directly acting air as heating medium. According to yet another embodiment, an output flow of humid air from the drying is directed to a condenser providing one output flow of dry air being recirculated back to the drying operation and one output liquid flow. According to the present process it is of interest to keep some media in a closed loop system. One such example may be the air driving the drying operation so that the risk of releasing odour is counteracted and controlled.

A process set-up or a plant according to the present invention may be operated so that produced heating energy from one step may be used to heat another step or several other steps. According to one embodiment, the phosphorus-rich biochar is directed to a cooling operation after the thermal treatment, said cooling operation providing heating energy used in the drying operation or elsewhere. This is visualised in FIG. 1 where it is shown that heat from either this cooling step and/or a volatiles combustion step may be used to heat the drying operation, e.g. via heat exchange. Fact is that the total energy balance of a process according to the present invention may be about plus/minus zero. If support fuel, such as straw or horse-dung, is added, the energy balance may also be improved according to the present invention.

One other important aspect of the present invention is the possibility of separation of different components in the thermal treatment. According to one embodiment of the present invention, the volatiles separated in the thermal treatment comprise cadmium. Also other heavy metals may be possible to separate so that the levels thereof are suppressed in the biochar product using other possible add-ons in or before/after the thermal treatment step. One possible additive to use is e.g. a chloride containing material as chloride ions may increase the evaporation removal effect for substances such as copper, zinc, nickel and lead. Moreover, the combination of chloride and a relatively high temperature within the range of 800-1100° C. may also be a possible effective tool for increasing the amounts of copper, zinc, nickel and lead in the stream of volatiles.

As also seen in FIG. 1, the volatiles separated in the thermal treatment may be directed to a combustion operation. The combustion operation suitably comprises a flue gas cleaning. Here cadmium contained is captured in an ash residue. Also the combustion operation may provide energy which is used in the drying operation and/or thermal treatment. Such energy may also be used in a nitrogen extraction step or plant in which the nitrogen rich liquid may be further processed.

### DETAILED DESCRIPTION OF THE DRAWINGS

In FIG. 1 one possible set-up according to the present invention is disclosed. A residual product starting material is dried with direct input air in a dryer. The drying air is circulated/generated in a condenser in which the air used in the drier is converted. Moreover, additives and/or support fuel may be added to the dryer and/or the subsequent thermal treatment. The output from the condenser is a nitrogen-rich liquid, however only very limited amounts of gases are flowed out in the atmosphere from the condenser or drying operation. The dried residual product is then directed to a thermal treatment operation (800-1100° C.), such as a pyrolysis, from which a nutrient-rich (phosphorous-rich and suitably also potassium-rich) biochar is produced. Moreover, volatiles containing e.g. cadmium and suitably also at least some copper, zinc, nickel and/or lead are separated in the thermal treatment. This stream of volatiles is then directed to combustion in which at least cadmium is separated in an ash residue during a subsequent flue gas cleaning after the actual combustion. As notable, heat produced in the combustion or in the cooling of the produced biochar may be used in other steps, such as in the operations of thermal treatment and/or drying.

As understood from above, it is important to realize that the drying operation according to the embodiment disclosed is optional according to the present invention. The method according to the present invention, involving the thermal treatment and separation, may be employed on a residual product material which has not been pre-treated with a drying operation such as disclosed above.

### EXAMPLES

The concept of the present invention has been tested by processing different residual products with a first drying operation and then a subsequent pyrolysis at 800° C. The amounts of phosphorous and cadmium were measured before and after the pyrolysis. The figures are presented below.

Trial no 1

| | Amount of P (g/kg) | Amount of Cd (mg/kg) |
|---|---|---|
| Dried material 1 | 34.39 | 0.97 |
| Solid product after the | 33.92 | 0.0174 |
| thermal treatment | | |
| Volatilized | 0.47 | 0.96 |
| Ratio volatilized | 1% | 98% |

Trial no 2

| | Amount of P (g/kg) | Amount of Cd (mg/kg) |
|---|---|---|
| Dried material 2 | 35.39 | 0.96 |
| Solid product after the | 34.07 | 0.059 |
| thermal treatment | | |
| Volatilized | 1.32 | 0.90 |
| Ratio volatilized | 4% | 94% |

Trial no 3.

| | Amount of P (g/kg) | Amount of Cd (mg/kg) |
|---|---|---|
| Dried material 3 | 19.76* | 0.30 |
| Solid product after the | 21.29* | 0.0 |
| thermal treatment | | |
| Volatilized | −1.53 | 0.30 |
| Ratio volatilized | 0% | 100% |

*Contains some form of measurement errors.

As notable from above, the level of phosphorous in the solid output from the pyrolysis, corresponding to the biochar product, was at least 96%, in fact 99% (trial no 1), 96% (trial no 2) and 100% (trial no 3, some kind of measurement errors). According to one specific embodiment, the level of phosphorous in the biochar is at least 90%, such as at least 95%, when compared to the amount of phosphorous in the input of dried residual product material going into the thermal treatment.

Moreover, the cadmium level in the volatiles was at least 94%, such as 98% (trial no 1), 94% (trial no 2) and 100% (trial no 3), when being compared to the input stream of dried residual product material. Therefore, according to yet another specific embodiment of the present invention, the level of cadmium in the separated volatiles is at least 90%, such as at least 95%, when compared to the amount of cadmium in the input of dried residual product material going into the thermal treatment.

1. A process for the treatment of a residual product for the production of a biochar, said process comprising:
providing a residual product material comprising at least phosphorous;
said process also being characterized by that it comprises
performing a thermal treatment of the residual product material in a temperature of 800-1100° C. in at least a low oxygen containing environment, for the separation of volatiles in a stream also comprising at least cadmium (Cd), if present, in the residual product material, and for the production of a nutrient-rich biochar comprising phosphorous,
wherein the volatiles separated in the thermal treatment are directed to a combustion operation
and wherein the combustion operation provides energy used in the thermal treatment and/or in a preceding drying operation.

2. The process according to claim 1, wherein the thermal treatment is pyrolysis.

3. The process according to claim 1, wherein a pH-regulating additive is added before the thermal treatment.

4. The process according to claim 1, wherein the thermal treatment is performed in a temperature of from 800-1000° C.

5. The process according to claim 1, wherein the thermal treatment also involves destruction of pathogenic material, organic residues like pharmaceutical residues, hormones, and organic pollutants, if present.

6. The process according to claim 1, wherein at least one additive of a chloride containing material and a silicate is added before the thermal treatment.

7. The process according to claim 1, wherein the thermal treatment is conducted on a residual product material having a dry matter level of at least 75%.

8. The process according to claim 1, wherein the thermal treatment is conducted on a residual product material having a dry matter level of at least 80%.

9. The process according to claim 1, wherein a drying operation performed in a temperature below 105° C. is conducted on the residual product material before the thermal treatment.

10. The process according to claim 9, wherein the drying operation is performed in a temperature of 40-70° C.

11. The process according to claim 9 or 10, wherein the drying operation is performed with directly acting air as heating medium.

12. The process according to claim 11, wherein an output flow of humid air from the drying is directed to a condenser providing one output flow of dry air being recirculated back to the drying operation and one output liquid flow.

13. The process according to claim 1, wherein a support fuel is added before or in the drying operation and/or the thermal treatment.

14. The process according to claim 1, wherein straw or horse-dung is added before or in the thermal treatment.

15. The process according to claim 1, wherein the phosphorus-rich biochar is directed to a cooling operation after the thermal treatment, said cooling operation providing heating energy used in the drying operation.

16. The process according to claim 1, wherein the volatiles separated in the thermal treatment are free from particulate material.

17. The process according to claim 1, wherein the volatiles separated in the thermal treatment comprise cadmium.

18-19. (canceled)

20. The process according to claim 1, wherein the level of phosphorous in the biochar is at least 90% when compared to the amount of phosphorous in the input of dried residual product material going into the thermal treatment.

21. The process according to claim 1, wherein the level of cadmium in the separated volatiles is at least 90% when compared to the amount of cadmium in the input of dried residual product material going into the thermal treatment.
